(19) United States
(12) Patent Application Publication
(10) Pub. No.: US 2009/0146346 A1
(43) Pub. Date: Jun. 11, 2009

(54) APPARATUS FOR MANUFACTURING THERMOPLASTIC RESIN FILM, AND METHOD FOR MANUFACTURING THERMOPLASTIC RESIN FILM

(75) Inventor: Masahiko Noritsune, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/327,434

(22) Filed: Dec. 3, 2008

(30) Foreign Application Priority Data
Dec. 5, 2007 (JP) 2007-314445
Feb. 20, 2008 (JP) 2008-038417

(51) Int. Cl. B29C 47/88

(52) U.S. Cl. 264/556; 425/326.1

(57) ABSTRACT

An apparatus for manufacturing a thermoplastic resin film includes a die which discharges a molten thermoplastic resin as a film, a cooling roll which is arranged so as to oppose to the discharge port of the die, and cools and solidifies the discharged film, and a variation reduction mechanism which reduces a variation of a wind speed in the vicinity of the surface of the film. The apparatus enables to provide a thermoplastic resin film which is suitable for an optical application, by controlling the thickness nonuniformity of the thermoplastic resin film in manufacturing the thermoplastic resin film by using a melt film-forming method.

### BACKGROUND OF THE INVENTION

1. Field of the Invention

The present invention relates to an apparatus for manufacturing a thermoplastic resin film and a method for manufacturing a thermoplastic resin film, and particularly relates to a technology for manufacturing a thermoplastic resin film which is used for an optical application such as a liquid crystal display.

2. Description of the Related Art

A thermoplastic resin made from a cellulosic resin, a cyclic-olefin-based resin and the like is widely used as a film for an optical application. In particular, the thermoplastic resin made from the cellulosic resin and the cyclic-olefin-based resin is used as an optical film for a liquid crystal display, because of having transparency, toughness, optical isotropy and the like.

A method for manufacturing the thermoplastic resin film includes a method of discharging a molten thermoplastic resin from a die as a film and cooling and solidifying the discharged film by using a plurality of cooling rolls (melt film-forming method, for instance). An unstretched thermoplastic resin film which has been manufactured with the method is used, for instance, as a film for protecting a liquid crystal display. A film which is produced by extending the unstretched thermoplastic resin film and developing retardation is used as a retardation film of the liquid crystal display.

The above described melt film-forming method has a problem that the film which has been discharged from the die is easily affected by a disturbance in a gap (air gap) until the film lands onto the cooling roll from the die, and causes thickness nonuniformity.

As this countermeasure, for instance, Japanese Patent Application Laid-Open No. 2006-150806 proposes a method for preventing a film from being affected by external air flow in an air gap, by surrounding the whole perimeter of the die and the cooling roll with a shielding member.

### SUMMARY OF THE INVENTION

However, the method described in Japanese Patent Application Laid-Open No. 2006-150806 shows a certain effect in reducing the thickness nonuniformity but cannot prevent the disturbance effectively and efficiently, because the air flow which causes the thickness nonuniformity is not analyzed.

The present invention is designed with respect to such a circumstance, and is directed at providing a method of manufacturing a thermoplastic resin film, which can reduce thickness nonuniformity occurring when the thermoplastic resin film is manufactured with a melt film-forming method and can obtain a thermoplastic resin film suitable for an optical application.

The present inventors found out that a temperature difference between the die and the cooling roll increases because the die is hot, and for instance, in a conventional touch roll system as illustrated for description in FIG. 23, an ascending air current (arrow) occurs in both ends of a film 6, which ascends toward a die 4, particularly, from both sides in a width direction of a space between a cooling roll 2 and a touch roll 3. This ascending air current causes a variation of a wind speed in the vicinity of the surface of the film in a space between the die and the surface of the cooling roll, and causes a distribution of the temperature (temperature nonuniformity) on the surface of the film. When the distribution of the temperature is formed on the surface of the film, the distribution can cause thickness nonuniformity when the film is cooled and solidified on the cooling roll.

Therefore, in order to achieve the above described object, the present inventors provide an apparatus for manufacturing a thermoplastic resin film including: a die which discharges a molten thermoplastic resin as a film; a cooling roll which is arranged so as to oppose to a discharge port of the die, and cools and solidifies the discharged film; and a variation reduction mechanism which reduces a variation of a wind speed by an ascending air current toward the die, in the vicinity of the surface of the film. The apparatus can reduce the variation of the wind speed by the ascending air current toward the die using the mechanism, and consequently can manufacture a film with reduced thickness nonuniformity.

The variation reduction mechanism may be a shielding device which shields at least an end in a width direction of the film until the film lands onto a surface of the cooling roll after having been discharged from the discharge port of the die, between an end in a width direction of the cooling roll and the end in the width direction of the film. Or the variation reduction mechanism may be an air-straightening device which straightens air in the vicinity of a surface of the film, until the film lands onto a surface of the cooling roll after having been discharged from the discharge port of the die.

A first aspect of the present invention provides an apparatus for manufacturing a thermoplastic resin film including: a die which discharges a molten thermoplastic resin as a film; a cooling roll which is arranged so as to oppose to a discharge port of the die, and cools and solidifies the discharged film; and a shielding device which shields at least an end in a width direction of the film until the film lands on a surface of the cooling roll after having been discharged from the discharge port of the die, between an end in a width direction of the cooling roll and the end in the width direction of the film.

According to the first aspect of the present invention, a shielding device shields at least an end in a width direction of the film, until the film lands on a surface of the cooling roll after having been discharged from the discharge port of the die, between an end in a width direction of the cooling roll and the end in the width direction of the film. Thereby, the shielding device can prevent an ascending air current from colliding with the vicinity of the surface of the film, until the film lands on the surface of the cooling roll after having been discharged from the die. Accordingly, the shielding device can reduce the variation of the wind speed in the vicinity of the surface of the film, which causes the thickness nonuniformity.

According to a second aspect of the present invention, in the apparatus according to the first aspect, the shielding device is a shielding plate which is provided in an approximately orthogonal direction to a surface of the film, between the end in the width direction of the cooling roll and the end in the width direction of the film.

The apparatus according to the second aspect has a shielding plate for shielding the end in the width direction of the film to be discharged, which is provided between the end in the width direction of the cooling roll and the end in the width direction of the film. The shielding plate can prevent an ascending air current from colliding with the vicinity of the surface of the film discharged from the die.

According to a third aspect of the present invention, in the apparatus according to the second aspect, a distance between the shielding plate and the end in the width direction of the film is 50 mm or less.

In the apparatus according to the third aspect, the distance between the shielding plate and the side face in the width direction of the film is narrowed. Accordingly, its shielding properties can be enhanced, and simultaneously, an ascending air current which directs toward the die from the surface of the cooling roll in the vicinity of the surface of the film can hardly be formed.

According to a fourth aspect of the present invention, in the apparatus according to the second or third aspect, the shielding device is provided so as to further surround the perimeter of the surface of the film. Thereby, the shielding device can surely prevent the ascending air current from colliding with the surface side of the film, and can prevent the thickness nonuniformity from forming.

According to a fifth aspect of the present invention, in the apparatus according to the first aspect, the shielding device includes: a housing which surrounds a space between a surface of the die in a longitudinal direction and the surface of the cooling roll, and has a labyrinth mechanism formed therein; and an air-flow forming device which forms air flow in an approximately orthogonal direction to the surface of the film, on the both ends in a width direction of the housing.

The apparatus according to the fifth aspect has a housing which surrounds a space between the surface of the die in a longitudinal direction and the surface of the cooling roll, and which has a labyrinth mechanism formed therein. Therefore, the apparatus can prevent an ascending air current from reaching the vicinity of the surface of the film which is discharged from the die. In addition, the apparatus forms air flow in a direction approximately orthogonal to the surface of the film, and accordingly can eliminate an ascending air current which flows in from both ends in the width direction. At this time, the air flow passes through the labyrinth mechanism in an inner part of the housing. Therefore, the air flow cushioned by the labyrinth mechanism does not disturb an air current in the vicinity of the surface of the film. The type of the air flow is not limited to air, but may be, for instance, an inert gas such as nitrogen gas.

According to a sixth aspect of the present invention, in the apparatus according to the fifth aspect, the air-flow forming device is a blowing nozzle or a suction nozzle.

Thus, the air-flow forming device forms the air flow in a direction approximately orthogonal to the surface of the film by using the blowing nozzle or the suction nozzle, and accordingly can shield an ascending air current which flows in from the ends in a width direction of the film.

In order to achieve the object, an apparatus for manufacturing a thermoplastic resin film according to a seventh aspect of the present invention includes: a die which discharges a molten thermoplastic resin as a film; a cooling roll which is arranged so as to oppose to a discharge port of the die, and cools and solidifies the discharged film; and an air-straightening device which is provided in the vicinity of the discharge port of the die and straightens air in the vicinity of a surface of the film, until the film lands onto a surface of the cooling roll after having been discharged from the discharge port of the die.

The apparatus according to the seventh aspect has an air-straightening device which is provided in the vicinity of the discharge port of the die, and which straightens air in the vicinity of the surface of the film to be discharged. Therefore, a variation of a wind speed is reduced by straightening the air current in the vicinity of the surface of the film, even though the ascending air current reaches the vicinity of the surface of the film. Usable devices as such an air-straightening device include, for instance, a blowing nozzle which sends air or a vacuum suction nozzle which vacuum-sucks air, and the like in a direction parallel to discharging direction of the film.

According to an eighth aspect of the present invention, in the apparatus according to the seventh aspect, the air-straightening device is provided in the vicinity of the discharge port of the die, and is a blowing nozzle or a suction nozzle which sends or sucks air in parallel to a discharging direction of the film.

According to a ninth aspect of the present invention, the apparatus according to any one of the first to eighth aspects, further includes: a measuring device which measures a temperature in the vicinity of the surface of the film; and a heating device which heats the vicinity of the surface of the film to a predetermined temperature based on the measured result.

The apparatus according to the ninth aspect can raise an atmospheric temperature around the die, and accordingly can reduce a temperature difference between the die and the atmosphere. Thereby, the apparatus can make an ascending air current hardly occur. The vicinity of the surface of the film specifically means a region 20 mm or less distant from the surface of the film.

Here, the heating device may be provided in a shielding device itself or in an inner side than the shielding device, and for instance, can include a method of embedding a heater in the shielding device itself.

According to a tenth aspect of the present invention, in the apparatus according to any one of the first to ninth aspects 1 to 9, an air gap between the discharge port of the die and a point where the film lands on the surface of the cooling roll is 200 mm or less.

In the apparatus according to aspect 10, the air gap is controlled to be 200 mm or less. Accordingly, an area of the film affected by a disturbance such as external air flow can be decreased. Thereby, the apparatus can prevent thickness nonuniformity from occurring.

According to an eleventh aspect of the present invention, the apparatus according to any one of the first to tenth aspects further includes a touch roll which is provided adjacent to the cooling roll, wherein the discharge port of the die is provided in a position lower than any one of the vertex of the cooling roll and the vertex of the touch roll.

In the apparatus according to the eleventh aspect, the discharge port of the die is provided in a position lower than any one of the vertex of the cooling roll and the vertex of the touch roll. Thereby, both sides of the film which has been discharged from the die are shielded by the cooling roll and the touch roll, and an ascending air current can be made to hardly collide with the film.

In order to achieve the object, a method for manufacturing a thermoplastic resin film according to a twelfth aspect of the present invention, includes the step of reducing a variation of a wind speed in the vicinity of the surface of the film using the apparatus for manufacturing the thermoplastic resin film according to any one of the first to eleventh aspect.

The method according to the twelfth aspect includes using the apparatus for manufacturing the thermoplastic resin film according to any one of the first to eleventh aspects. Accordingly, an ascending air current toward the vicinity of the surface of the film can be shielded or air in the vicinity of the surface of the film can be straightened. Accordingly, occurrence of a distribution (nonuniformity) of a wind speed in the vicinity of the surface of the film can be prevented or a distribution (nonuniformity) of a wind speed can be decreased.

In order to achieve the object, a third aspect of the present invention provides a method for manufacturing a thermoplastic resin film including the steps of: discharging a molten thermoplastic resin from a die as a film; cooling and solidifying the discharged film on a cooling roll, and controlling a variation of a wind speed in the vicinity of a surface of the discharged film to be 0.5 m/second or less.

The ascending air current described in FIG. 23 causes the variation of the wind speed in the vicinity of the surface of the film between the die and the surface of the cooling roll, and becomes a reason of causing the temperature distribution (nonuniformity) on the surface of the film. When such a temperature distribution occurs on the surface of the film, the distribution can cause the thickness nonuniformity when the molten resin is cooled and solidified on the cooling roll. In the method according to the thirteenth aspect, the variation of the wind speed is controlled to be 0.5 m/second or less, and thereby the occurrence of the temperature distribution which causes the above described thickness nonuniformity can be prevented.

According to a fourteenth aspect of the present invention, the method according to the thirteenth aspect further includes the step of straightening air in the vicinity of the surface of the film, until the film lands onto a surface of the cooling roll after having been discharged from the die.

According to a fifteenth aspect of the present invention, in the method according to the fourteenth aspect, the air-straightening is performed by sending or sucking air in parallel to a discharging direction of the film.

According to a sixteenth aspect of the present invention, the method according to any one of the thirteenth to fifteenth aspects, further includes the step of controlling a wind speed in the vicinity of the surface of the film to be 1 m/second or less.

The method according to aspect 16 controls the wind speed in the vicinity of the surface of the film into a small value, and accordingly can control the thickness nonuniformity which is caused by the effect of the wind speed.

In aspect 17 of the present invention, a temperature difference between the vicinity of the surface of the film and the die in a method in any one of aspects 13 to 16 is controlled into a range of 160° C. or lower.

The method according to aspect 17 controls a difference between an atmospheric temperature in the vicinity of the surface of the film and the temperature of the die into a range of 160° C. or lower, and accordingly can make an ascending air current originating in the difference between temperatures of the die and the atmospheric temperature hardly occur.

According to an eighteenth aspect of the present invention, in the method according to any one of the thirteenth to seventeenth aspects, the cooling roll is a touch roll type.

In such a touch roll system, the cooling roll can wholly pressurize a surface of the molten film which has been discharged from the die, and accordingly can reduce all of the nonuniformity of Re and Rth, and unevenness in the plane.

According to a nineteenth aspect of the present invention, in the method according to any one of the thirteenth to eighteen aspects, the thermoplastic resin shows a gradient of a viscosity of 1.7 Pa·s/° C. or higher by an absolute value, while the thermoplastic resin is in a temperature range of (T−10)° C. or higher but T° C. or lower, when a temperature of the molten resin right after having been discharged from the die is defined as T (° C.).

The method according to the nineteenth aspect, applies the present invention the to thermoplastic resin which shows a gradient of a viscosity of 1.7 Pa·s/° C. or higher by an absolute value, while the thermoplastic resin is in a temperature range of (T−10)° C. or higher but T° C. or lower, when a temperature of the molten resin right after having been discharged from the die is defined as T (° C.). A resin with a high temperature-dependency of melt viscosity is easily affected by temperature variation due to the variation of the wind speed, consequently varies the viscosity greatly, and accordingly tends to cause thickness nonuniformity. The method according to the present invention can significantly suppress the thickness nonuniformity, by making the ascending air current hardly occur in such a case.

According to a twelfth aspect of the present invention, in the method according to any one of the thirteenth to nineteenth aspects, the thermoplastic resin is a cellulosic resin or a cyclic-olefin-based resin.

This is because the cellulosic resin and the cyclic-olefin-based resin particularly among thermoplastic resin films are suitable for a film for an optical application because of their transparency, toughness, optical isotropy and the like.

According to a twenty-first aspect of the present invention, in the method according to the thirteenth to twelfth aspects, the film has a thickness nonuniformity of 1 μm or less.

When a thermoplastic resin film for an optical application is manufactured with a manufacturing method according to the present invention, the manufactured optical film can show an adequate plane state with the thickness nonuniformity of 1 μm or less.

According to any of the aspects of the present invention, thickness nonuniformity of a film in manufacturing a thermoplastic resin film by using a melt film-forming method can be suppressed and a thermoplastic resin film which is suitable for an optical application can be obtained.

### BRIEF DESCRIPTION OF THE DRAWINGS

FIG. 1 is a whole schematic diagram illustrating an example of an apparatus for manufacturing a thermoplastic resin film according to a first embodiment;

FIG. 2 is a sectional view illustrating a structure of an extruder according to the first embodiment;

FIG. 3 is an enlarged perspective view illustrating a structure between a die and a cooling roll according to the first embodiment;

FIG. 4 is a side view in which the structure in FIG. 3 is viewed from an X direction;

FIG. 5 is a side view in which the structure in FIG. 3 is viewed from a Y direction;

FIG. 6 is an enlarged sectional view of a shielding plate in the vicinity of a surface of the cooling roll in FIG. 3;

FIG. 7 is a perspective view illustrating a temperature control mechanism which is provided in the vicinity of a surface of a film according to the first embodiment;

FIG. 8 is an enlarged perspective view illustrating another structure between a die and a cooling roll according to the first embodiment;

FIG. 9 is a side view in which the structure in FIG. 8 is viewed from an X direction;

FIG. 10 is a perspective view illustrating a temperature control mechanism which is provided in the vicinity of a surface of a film in FIG. 8;

FIG. 11 is a perspective view for describing another aspect of a shielding mechanism according to the first embodiment;

FIG. 12 is a side view in which the shielding mechanism of FIG. 11 is viewed from an X direction;

FIG. 13 is a side view for describing further another aspect of a shielding mechanism according to the first embodiment;

FIG. 14 is a side view in which the shielding mechanism of FIG. 13 is viewed from an X direction;

FIG. 15 is a perspective view for describing a shielding mechanism according to a second embodiment;

FIG. 16 is a side view in which the shielding mechanism of FIG. 15 is viewed from an X direction;

FIG. 17 is a perspective view for describing another aspect of a shielding mechanism according to the second embodiment;

FIG. 18 is a side view in which the shielding mechanism of FIG. 17 is viewed from an X direction;

FIG. 19 is a block diagram of a case in which a film which has been manufactured in the present embodiment is longitudinally stretched and transversely stretched;

FIG. 20 is the Table showing the result of the present examples;

FIG. 21 is the Table showing the result of the present examples;

FIG. 22 is an enlarged sectional view illustrating a structure between a die and a cooling roll in a casting roll system according to the present example; and

FIG. 23 is an enlarged perspective view illustrating a conventional structure between a die and a cooling roll.

### DETAILED DESCRIPTION OF THE PREFERRED EMBODIMENTS

Preferred embodiments of a method for manufacturing a thermoplastic resin film according to the present invention will now be described below with reference to the attached drawings. A range of numeric values which are expressed by using “to” in the present specification means a range including the numeric values described around “to” as the lower limit and the upper limit, respectively.

At first, a first embodiment of the present invention will now be described. The present embodiment shows an example of shielding a film by installing a shielding plate or by forming an air flow in at least an end in a width direction of a film to inhibit an ascending air current to collide with the vicinity of the surface of the film.

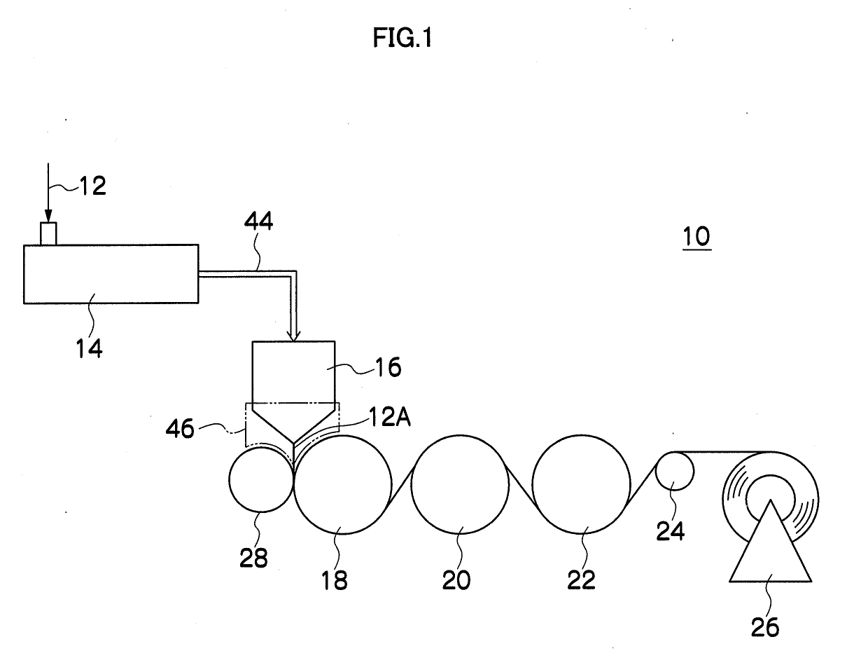

FIG. 1 is a schematic diagram illustrating an example of a manufacturing apparatus for conducting a method for manufacturing a thermoplastic resin film according to a first embodiment of the present invention. The present embodiment shows an example of manufacturing a cellulose acylate film. However, the present invention is not limited to the cellulose acylate film, but can be applied to other thermoplastic resin films such as a cyclic-olefin-based resin film.

As is illustrated in FIG. 1, a manufacturing apparatus 10 is mainly composed of an extruder 14 for melting a cellulose acylate resin 12, a die 16 for discharging a molten cellulose acylate resin 12 as a film, a plurality of cooling rolls 18, 20 and 22 of a multistage for cooling a cellulose acylate film 12A (hereinafter referred to as film 12A) in a hot and molten state after having been discharged from the die 16, a stripping roll 24 for stripping the film 12A from the last cooling roll 22, and a winder 26 for winding the cooled film 12A.

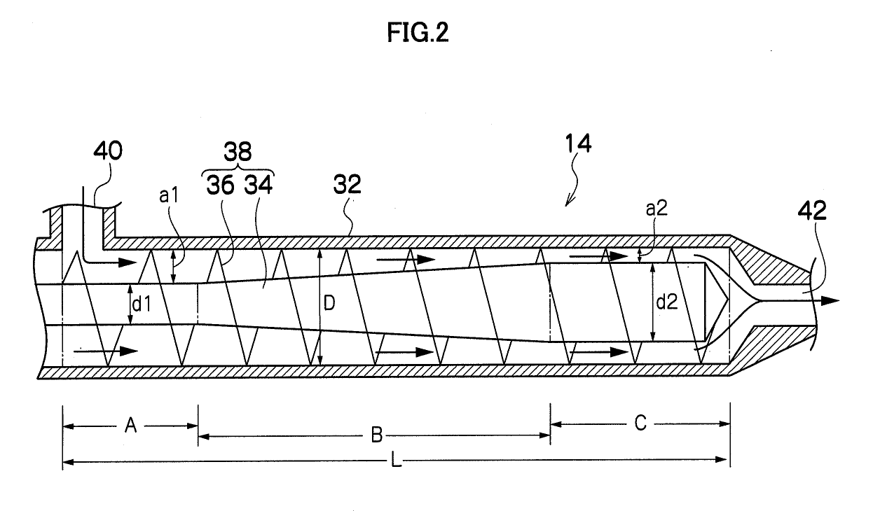

FIG. 2 is a sectional view illustrating a structure of the extruder 14. As is illustrated in FIG. 2, a single axis screw 38 which has a flight 36 attached on a screw shaft 34 is provided in a cylinder 32 of the extruder 14. This single axis screw 38 is structured so as to be rotated by an unshown motor. An unshown hopper is installed at a supply port 40 of the cylinder 32. The cellulose acylate resin 12 is supplied to the cylinder 32 through the supply port 40 from this hopper.

The inner part of the cylinder 32 comprises, sequentially from a supply port 40 side, a supply zone (region shown by (A)) for quantitatively transporting the cellulose acylate resin which has been supplied from the supply port 40, a compression zone (region shown by (B)) for kneading and compressing the cellulose acylate resin, and a metering zone (region shown by (C)) for weighing the kneaded and compressed cellulose acylate resin. The cellulose acylate resin which has been melted in the extruder 14 is continuously transported to the die 16 from the supply port 42.

The screw compression ratio of the extruder 14 is preferably set at 1.5 to 4.5, and a ratio of the cylinder length to an inner diameter of the cylinder (L/D) is preferably set at 20 to 70. Here, the screw compression ratio is expressed by a volume ratio of a supply zone (A) to a metering zone (C), in other words, by a volume of the supply zone (A) per unit length divided by a volume of the metering zone (C) per unit length, and is calculated by using an outer diameter d1 of the screw shaft 34 in the supply zone (A), an outer diameter d2 of the screw shaft 34 in the metering zone (C), a groove diameter a1 of the supply zone (A) and a groove diameter a2 of the metering zone (C). The extrusion temperature is preferably 190 to 300° C. In order to prevent the molten resin from being oxidized due to remaining oxygen, it is preferable to extrude the molten resin while filling the inside of an extruder with an current of an inert gas (nitrogen or the like) or evacuating the inside of the extruder by using the extruder provided with a vent.

The cellulose acylate resin 12 which has been melted by the extruder 14 is sent to the die 16 through a pipe 44 (see FIG. 1), and is discharged from the discharge port of the die as a film. It is preferable to control the variation of the discharge pressure when discharging a molten resin from the die 16 to 10% or less.

As is illustrated in FIG. 1, three cooling rolls 18, 20 and 22 are arranged in multiple steps in a downstream side of the die 16. The cooling roll 18 is configured so as to cool and solidify the molten resin 12A by sandwiching the molten resin 12A between itself and the adjacently provided touch roll 28.

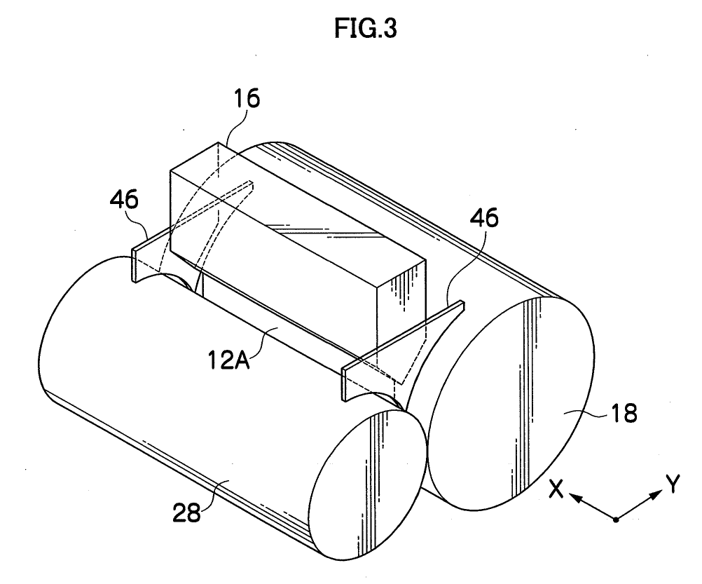

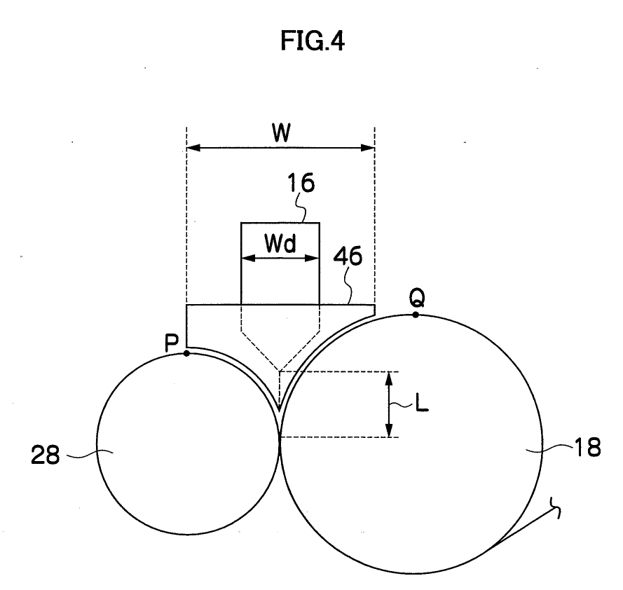

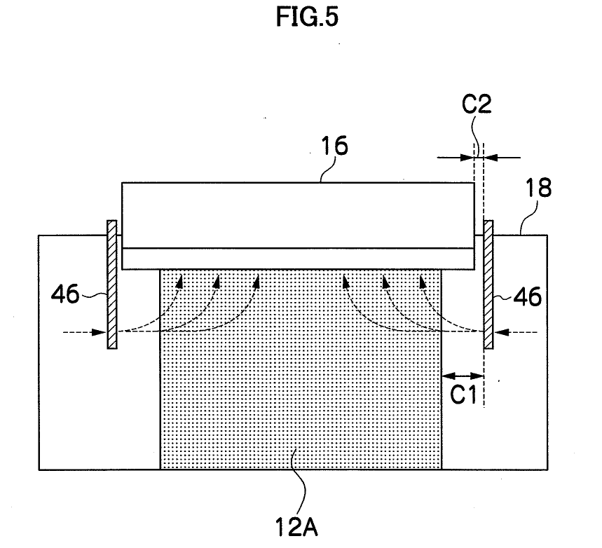

FIG. 3 is a perspective view illustrating a structure between a die 16 and a cooling roll 18. FIG. 4 is a side view in which the structure in FIG. 3 is viewed from an X direction. FIG. 5 is a sectional view which is revealed when the structure in FIG. 3 is cut toward a Y direction from a centerline in a thickness direction of the die 16.

As is illustrated in FIG. 3, a pair of shielding plates 46 and 46 is provided in a space between the discharge port of the die 16 and the surface of the cooling roll 18, so as to surround both ends in a width direction of the film 12A.

Each shielding plate 46 is provided in an inner side than both ends of the cooling roll 18 through a gap apart from the side face in a width direction of the die 16. Each shielding plate 46 may be directly fixed on the side face of the die 16, or may be supported and fixed by an unshown supporting member.

A width W of the shielding plate 46 is provided so as to effectively shield an ascending air current due to the heat radiation of the die 16, and, for instance, is preferably equal to or greater than a width Wd of the side face of the die 16, as is illustrated in FIG. 4.

The discharge port of the die 16 is preferably provided so as to be in a position lower than any one of the vertex P of the touch roll 28 and the vertex Q of the cooling roll 18. Thereby, the discharge port of the die 16 is shielded from the outside in a space between the cooling roll 18 and the touch roll 28, and accordingly can make the film 12A to be discharged from the die 16 hardly be affected by the ascending air current or the like.

An air gap L between the discharge port of the die 16 and the surface of the cooling roll 18 is preferably 200 mm or less, in order to make the film 12A hardly affected by the external air flow (including ascending air current).

A clearance C1 between the end in the width direction of the shielding plate 46 and the end in the width direction of the film 12A is preferably narrowly formed so that the ascending air current flowing along the surface of the cooling roll 18 can be efficiently shielded, and is preferably approximately 50 mm from the end in the width direction of the film 12A, as is illustrated in FIG. 5. Here, a clearance C2 between the side face of the die 16 and the shielding plate 46 does not necessarily need to be provided, but is preferably formed to be, for instance, 10 mm or less so that an air current in a space surrounded by the shielding plate 46 can be exhausted.

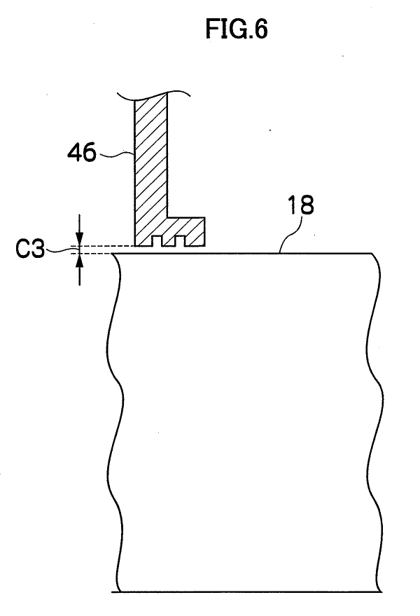

FIG. 6 is a sectional view illustrating a space between a lower end of the shielding plate 46 and the cooling roll 18. As is illustrated in FIG. 6, the lower end of the shielding plate 46 has a labyrinth mechanism so as to effectively inhibit air from flowing into a die 16 side from both ends in the width direction of the cooling roll 18. In the figure, the shielding plate 46 has the labyrinth mechanism formed thicker than itself to increase the flow resistance of air and enhance the shielding characteristics. However, the thickness is not limited to the above thickness, and the labyrinth mechanism may be formed so as to have the same thickness as the shielding plate. A clearance C3 between the shielding plate 46 and the surface of the cooling roll 18 is preferably set to be 10 mm or less, in such a range that the lower end (salient of labyrinth mechanism in FIG. 6) of the shielding plate 46 does not contact the surface of the cooling roll 18.

When the shielding plate 46 is configured in this way, the variation of the wind speed in a space surrounded by the shielding plates 46 is controlled to be 0.5 m/second or less, preferably to be 0.3 m/second or less, and more preferably to be 0.1 m/second or less. An absolute value of the wind speed is preferably controlled to 1 m/second or smaller.

The wind speed in the vicinity of the surface of the film 12A can be measured by using a well-known anemometer, for instance, a wind speed indicator Anemomaster (Main body: MODEL6162, and Probe: MODEL204) made by Kanomax Japan, Inc., or the like. The wind speed in the vicinity of the surface of the film 12A is defined as a measurement value in a position which is 20 mm or less distant from the surface (film surface) of the film 12A.

The shielding plate 46 has preferably superior wind shielding characteristics and heat retention characteristics, and for instance, a metal plate made from stainless steel or the like can be preferably used.

An ascending air flow which affects thickness nonuniformity of a film 12A is generated mainly because a die 16 is hot, which causes a large temperature difference between the die and a surrounding atmosphere and/or between the die and a temperature of the surface of a cooling roll 18 and so on. Then, it is possible to make the ascending air flow hardly occur, by raising an atmospheric temperature in the vicinity of the surface of the film 12A, and consequently decreasing the temperature difference between the atmospheric temperature and the die 16.

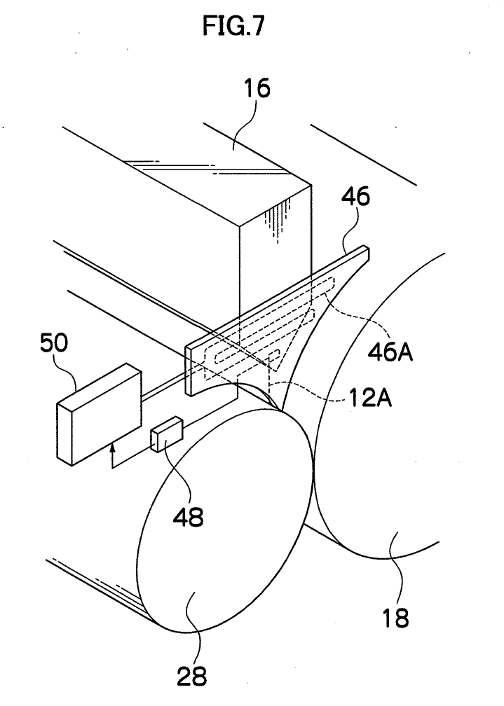

FIG. 7 is a perspective view illustrating one example of a structure having a temperature control mechanism provided in the vicinity of the surface of the film 12A.

As is illustrated in FIG. 7, a heater 46A (heating device) for heating a space surrounded by shielding plates 46 is embedded in the shielding plate 46, and the heater 46A is connected with a controlling device 50. In the vicinity of the surface of the film 12A, a temperature sensor 48 is provided, and is structured so that the measurement result can be output to the controlling device 50. The temperature sensor 48 measures the temperature in the vicinity of the surface of the film 12A, and the controlling device 50 then controls the heating temperature of the heater 46A embedded in the shielding plate 46 based on the measurement result. Thereby, a temperature difference between the atmosphere in the vicinity of the surface of the film 12A and the die 16 can be controlled into a predetermined range.

The temperature sensor 48, for instance, is preferably installed in a position which is 20 mm or less apart from the surface of the film 12A.

The heating device is not limited to the above described heater, but various heating devices can be used. In the present embodiment, the heater 46A is embedded in the shielding plate 46, but not limited to the method, but the heater may be provided in a different position from that in the shielding plate 46.

In addition, an exhausting device (not shown) may be provided for the purpose of exhausting the ascending air current from a space surrounded by the shielding plates 46. Such an exhausting device is not particularly limited, but for instance, a suction pump, an ejector or the like can be used.

A touch roll method is a method of placing a touch roll on a cast drum to shape the surface of the film. A touch roll 28 preferably does not have high rigidity of a usual level, but preferably has elasticity. Thereby, the touch roll 28 can control the surface unevenness into the range of the present invention or less, by its excessive plane pressure. In order to do this, it is necessary to control the thickness of an external cylinder to be thinner than a usual roll. The thickness (Z) of the external cylinder is preferably 0.05 mm to 7.0 mm, more preferably is 0.2 mm to 5.0 mm, and further preferably is 0.3 mm to 3.5 mm. The touch roll may be a roll arranged on a metal shaft and a heat medium (fluid) may run between the touch roll and the metal shaft. Or, the touch roll may be a roll in which an elastic body layer is arranged on the external cylinder and the metal shaft, and a space between the external cylinder and the elastic body layer is filled with the heat medium (fluid).

The temperature of the touch roll is preferably set at 60° C. to 160° C., more preferably is set at 70° C. to 150° C., and further preferably is set at 80° C. to 140° C. Such a temperature control can be achieved by passing a liquid or gas of which the temperature has been controlled, through the inner part of the roll. In this way, the roll preferably has a temperature control mechanism provided therein.

A material of the touch roll is preferably a metal, and more preferably is a stainless steel. A touch roll having a plated surface is also preferable. On the other hand, a rubber roll or a metal roll which has been lined with rubber is not preferable because the unevenness of the rubber surface is too large to form a thermoplastic resin film having the above described surface unevenness.

The surface of the touch roll and a casting roll has an arithmetic average height Ra of 100 nm or smaller, preferably of 50 nm or smaller, and more preferably of 25 nm or smaller.

As for a temperature condition for cooling the resin in multiple steps by using a plurality of cooling rolls, the temperatures of the surfaces of the rolls are preferably set to sequentially become lower from an upstream side in a transport direction of the film.

Next, working in an apparatus for manufacturing the thermoplastic resin film according to the present invention will now be described below with reference to FIG. 3 and FIG. 5.

A film 12A which has been discharged from a die 16 lands on the surface of a cooling roll 18, and is then cooled and solidified while being sandwiched between the cooling roll 18 and a touch roll 28, as is illustrated in FIG. 3.

At this time, an ascending air current (dotted arrow) which flows toward the discharge port of the die 16 from both ends in a width direction of the cooling roll 18 is shielded by a pair of shielding plates 46, as is illustrated in FIG. 5. Thereby, the shielding plate can prevent the ascending air current which flows toward the die 16 from the surface of the cooling roll 18 from flowing into the periphery of the film 12A. Thereby, a variation of a wind speed in the vicinity of the surface of the film 12A is controlled to 0.3 m/second or less, so that the thickness nonuniformity of the film 12A can be prevented.

Furthermore, when a temperature control mechanism is provided in the shielding plate as is illustrated in FIG. 7, the temperature control mechanism adjusts a temperature difference ΔT between the vicinity of the surface of the film 12A and the die 16 to 160° C. or lower. Specifically, when the temperature of the die 16 is approximately 240° C., the temperature control mechanism controls an atmospheric temperature in the vicinity of the surface of the film 12A to 80° C. or higher. Thereby, a temperature difference between the die 16 and the periphery can be reduced, which can make an ascending air current hardly occur.

As described above, the manufacturing apparatus according to the present embodiment can prevent an ascending air current from the surface of the cooling roll 18 from flowing into an air gap between the die 16 and the surface of the cooling roll 18, in a melt film-forming process for forming the film 12A. Thereby, the manufacturing apparatus prevents the wind speed from varying due to the ascending air current in the vicinity of the surface of the film 12A, and accordingly can prevent thickness nonuniformity from forming in the film 12A. Accordingly, the manufacturing apparatus can manufacture a cellulose acylate film which has a superior plane shape and is suitable for an optical application.

The present embodiment showed an example in which an air gap between the die 16 and the cooling roll 18 was short and a shielding plate 46 was provided only in both side faces in a width direction of the die 16, but when the air gap is long, it is preferable to structure a shielding device which has the shielding plate 46 further provided in such a position as to oppose to the surface of the film 12A, and surrounds the whole perimeter of the film 12A. Thereby, the shielding device can shield not only an ascending air current which flows in from the both ends in the width direction of the cooling roll 18, but also an ascending air current which flows toward the die 16 from the surface of the cooling roll 18 through the vicinity of the surface of the film 12A, and an ascending air current which flows toward the die 16 from the surface of the touch roll 28 through the vicinity of the surface of the film 12A.

In this case, the shielding plate 46 which opposes to the surface of the film 12A is preferably provided so as to be 200 mm or less apart from the surface of the film 12A.

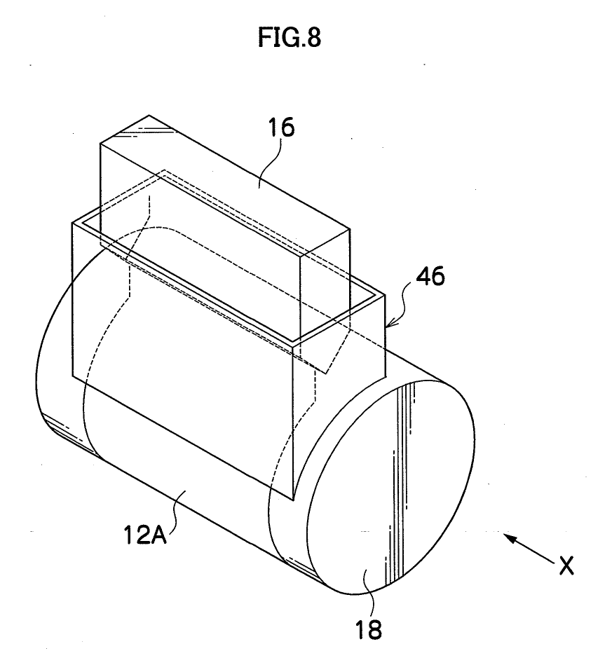

In the present embodiment, an example was described which employed a cooling roll 18 of a touch roll type, but the cooling roll 18 is not limited to the above type. The cooling roll 18 can employ, for instance, a casting roll type as illustrated in FIG. 8.

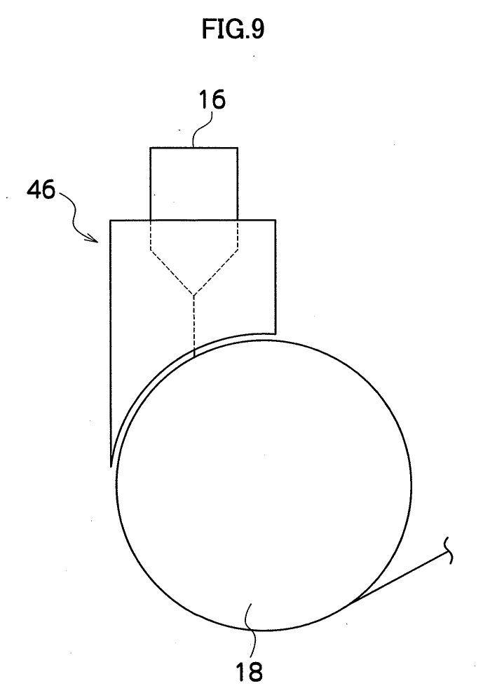

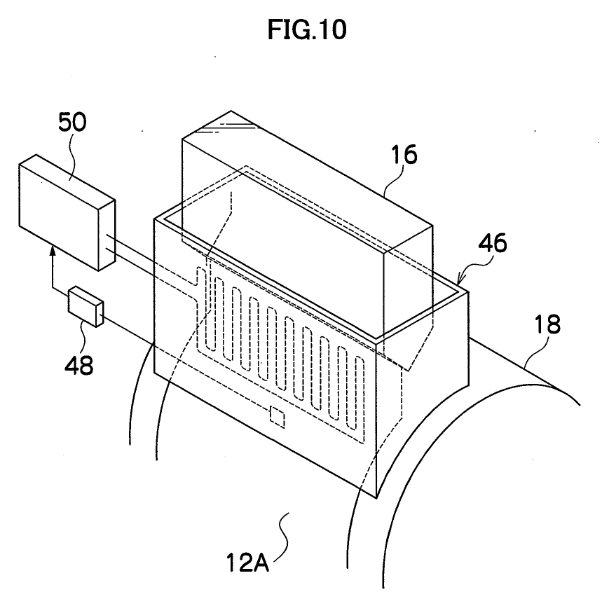

FIG. 8 is an enlarged perspective view illustrating a structure including a space between a die and a cooling roll, in a casting roll system. FIG. 9 is a side view in which the structure in FIG. 8 is viewed from an X direction. FIG. 10 is a perspective view of a case in which a temperature control mechanism is provided in a shielding plate of FIG. 8. In the figures, the same members as in FIG. 4 will be designated by the same reference numerals, and the detailed description will be omitted.

As is illustrated in FIG. 8, the shielding plate 46 is provided not only in both ends in the width direction of the film 12A among spaces between the die 16 and the cooling roll 18, but also above the cooling roll 18 so as to surround the surface of the film 12A.

In this case, the shielding plate 46 (shielding plate in left side in FIG. 9) which is arranged so as to oppose to the surface of the film 12A is preferably provided so as to slightly project farther than the surface of the cooling roll 18. That is, in the example shown in FIG. 9, the shielding plate 46 is located on the further left side of the left periphery (leftmost point) of the cooling roll 18.

In addition, when a temperature control mechanism is provided in the shielding plate 46, an atmospheric temperature in a space surrounded by the shielding plate 46 can be controlled to a predetermined temperature, as is illustrated in FIG. 10. Thereby, the shielding plate 46 can decrease a difference between the atmospheric temperature and the temperature of the die 16, and accordingly can prevent an ascending air current from forming. The temperature control mechanism has the same structure as the above described structure illustrated in FIG. 7.

In the embodiment illustrated in FIG. 8, a structure was described in which the shielding plate surrounded both faces (whole perimeter) of a film 12A, but the structure is not limited to the above one. For instance, the shielding plate may be configured so as to surround only a face in one side of the film 12A. It is preferable in particular to make the shielding plate shield a face of a side which does not contact a cooling roll 18, among surfaces of the film 12A. Thereby, the shielding plate can effectively shield the ascending air current, and accordingly can inhibit thickness nonuniformity from forming in the film 12A.

In the above, the preferred embodiment of a method for manufacturing a thermoplastic resin film according to the present invention was described, but the present invention is not limited to the embodiment, and various aspects can be adopted.

For instance, it is effective in the present embodiment to apply the present invention to a molten resin having high temperature-dependency of a viscosity, in particular. The molten resin having the high temperature-dependency includes specifically a thermoplastic resin which shows a gradient of a viscosity of a film of 1.7 Pa·s/° C. or higher by an absolute value, while the resin is in a temperature range of (T−10) to T (° C.), when a temperature of the molten resin of the film 12A right after having been discharged from the die 16 is defined as T (° C.). When such a resin is used, the manufacturing apparatus can significantly reduce the variation of the temperature (temperature fluctuation) of the film 12A in a molten state, that is to say, the variation of the viscosity (viscosity fluctuation) by controlling the variation of the wind speed, and can significantly improve the thickness nonuniformity.

The viscosity of the molten resin can be measured by using, for instance, a viscoelasticity measurement apparatus by using a cone plate (Modular Compact Rheometer: Physica MCR301 made by Anton Paar GmbH, for instance). The viscosity of the molten resin can be measured on measurement conditions of sufficiently drying the thermoplastic resin until the water content reaches 0.1% or lower, and then measuring a shear speed in a form of 1 (/second) at a predetermined temperature (temperature close to the temperature of the molten resin).

In the present embodiment, an example was used for description, which shields an ascending air current by using a shielding plate 46, but the present invention is not limited to the shielding plate. For instance, the ascending air current can be shielded by forming an air flow.

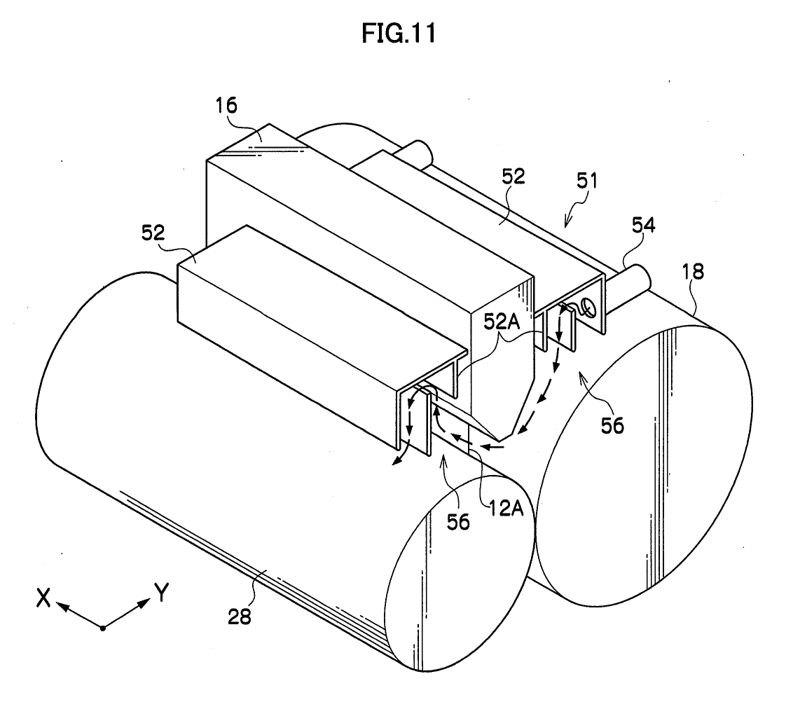

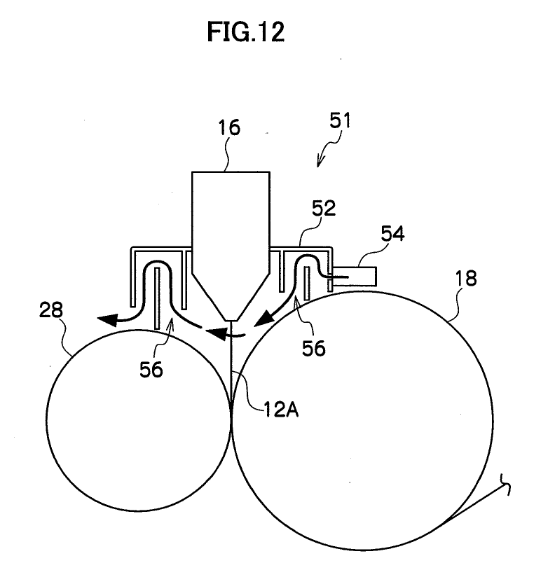

FIG. 11 is a view for describing another aspect of a shielding mechanism according to the present invention. FIG. 12 is a side view in which the shielding mechanism of FIG. 11 is viewed from an X direction.

As is illustrated in FIG. 11, a shielding mechanism 51 has a housing 52 which surrounds a space between the surface of a die 16 in a longitudinal direction and the surface of a cooling roll 18, and a blowing nozzle 54 for forming the air flow in a Y direction is connected to the both ends in the width direction of the housing 52 so as to shield the end in the width direction of the film 12A.

The blowing nozzle 54 is connected to an unshown blower, and is structured so as to blow a clean air. The blowing nozzle 54 is also provided with an unshown temperature control mechanism which can control a blast temperature.

The housing 52 to which the blowing nozzle 54 is connected has a labyrinth mechanism 56 which is made from a plurality of baffles 52A formed in both ends in a width direction of the housing. Thereby, the air which has been supplied to the housing 52 from the blowing nozzle 54 is cushioned and simultaneously straightened when passing through the labyrinth mechanism 56, and then forms an air flow in a Y direction so as to shield the end in the width direction of the film 12A. The air which has been thus supplied from the blowing nozzle 54 is cushioned when passing through the labyrinth mechanism 56, and accordingly does not disturb an air current in the vicinity of the surface of the film 12A.

A flow rate of the air which shields the end in the width direction of the film 12A is preferably set at 0.6 to 1.0 m/second. A blast temperature is preferably set at approximately Tg±20° C. (approximately 140° C., for instance), because when the blast temperature is too high, the film 12A is easy to cause neck-in.

A space between the end in the width direction of the film 12A and the formed air flow is preferably in a range of 50 mm or more.

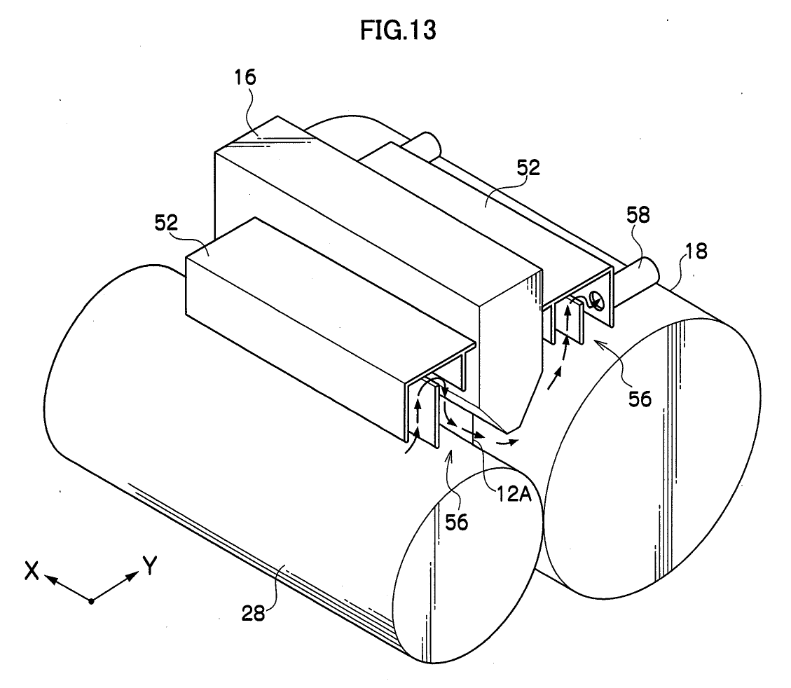

In the embodiment in FIG. 11, an example was used for description, which used a blowing nozzle 54 as an air-flow forming device. However, the air-flow forming device is not limited to the blowing nozzle, but may form an air flow so as to shield an end in a width direction of a film 12A by a suction nozzle 58, as is illustrated in FIG. 13.

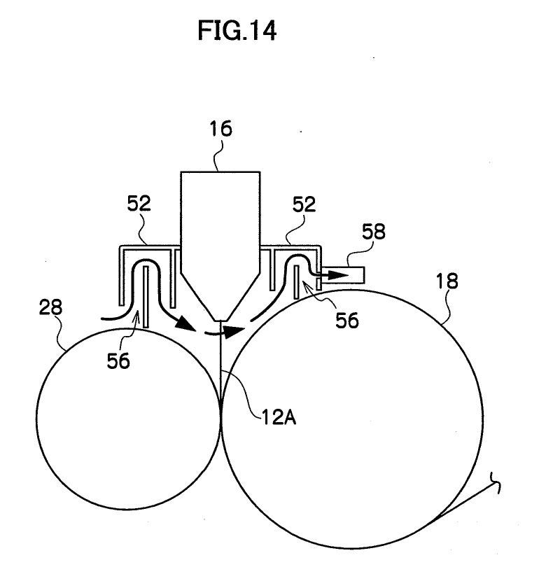

FIG. 13 is a perspective view for describing further another aspect of a shielding mechanism according to the present invention. FIG. 14 is a side view in which the shielding mechanism of FIG. 13 is viewed from an X direction.

As is illustrated in FIG. 13, the shielding mechanism is structured in the almost same way as in FIG. 11, except that a suction nozzle 58 is provided in place of the blowing nozzle 54. In the figures, the members having the same function as those in FIG. 11 and FIG. 12 will be designated by the same reference numerals, and the detailed description will be omitted.

The shielding mechanism thus makes the suction nozzle 58 suck the end in the width direction of the film 12A, and thereby can form a moderate air flow so as to shield the end in the width direction of the film 12A. Accordingly, the shielding mechanism does not make the air flow disturb the air current in the vicinity of the surface of the film 12A, and can prevent an ascending air current from flowing in from both ends in the width direction of the film 12A.

Next, a second embodiment of the present invention will now be described. The present embodiment shows an example of reducing a variation of a wind speed in the vicinity of a surface of a film, by providing an air-straightening device which straightens an air current in the vicinity of the surface of the film.

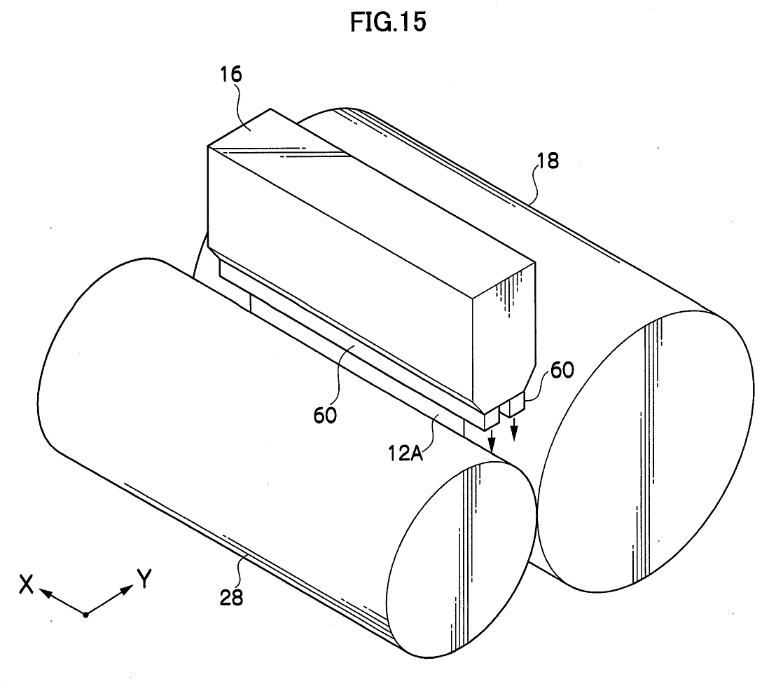

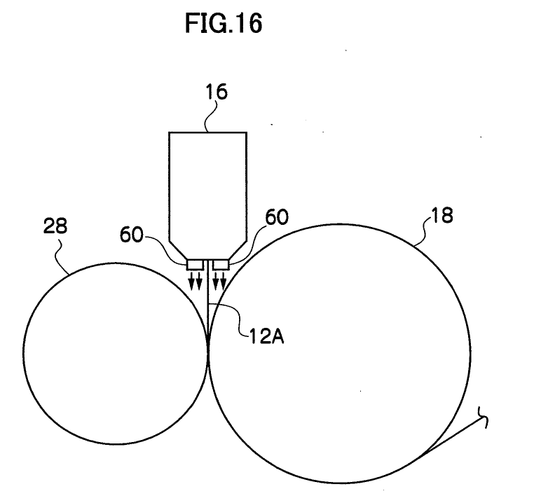

FIG. 15 is a perspective view for describing another aspect of an apparatus provided with a blowing nozzle 60 (air-flow forming device) for manufacturing a thermoplastic resin film according to the present invention. FIG. 16 is a side view in which the manufacturing apparatus of FIG. 15 is viewed from an X direction. In the figures, the members having the same function as in the above described first embodiment will be designated by the same reference numerals, and the detailed description will be omitted.

As is illustrated in FIG. 15, a pair of blowing nozzles 60 is provided in the discharge port of a die 16 along a longitudinal direction of the die 16.

The blowing nozzle 60 is connected to an unshown pump and the like, and uniformly sends clean air in a discharge direction (downward vertical direction) along the surface of a film 20A. Thereby, the blowing nozzle 60 cancels an ascending air current by the clean air which flows in an opposite direction to the ascending air current, as is illustrated in FIG. 16, even when the ascending air current has been generated in the vicinity of the surface of the film 20A, and thereby can reduce the variation of the wind speed in the vicinity of the surface of the film 12A.

A flow rate of the air which is sent from the blowing nozzle 60 is preferably set at a speed necessary for cancelling the ascending air current, specifically, at 0.6 to 1.0 m/second. In the above description, the flow rate of the air is defined as a value in a position such as to be 20 mm or less apart from the film surface of the film 12A. When a blast temperature is too high, the film 12A is easy to cause neck-in, so that the blast temperature is preferably set at approximately Tg±20° C. (140° C., for instance).

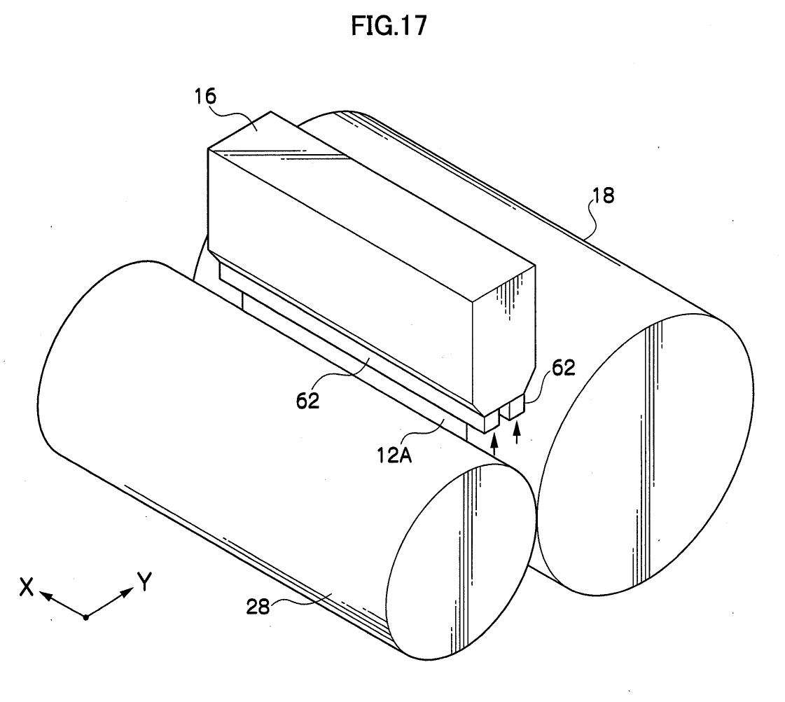

An air-straightening device is not limited to the blowing nozzle 60, but may be a suction nozzle 62 as illustrated in FIG. 17, for instance.

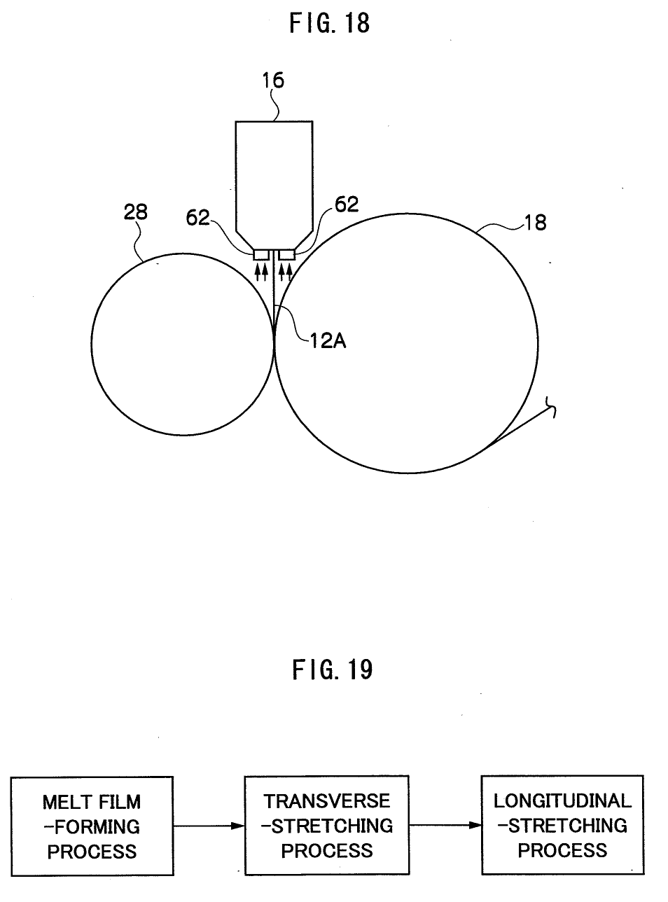

FIG. 17 is a perspective view for describing another aspect of an apparatus provided with the suction nozzle 62 (air-straightening device) for manufacturing a thermoplastic resin film according to the present invention. FIG. 18 is a side view in which the manufacturing apparatus of FIG. 17 is viewed from an X direction.

As is illustrated in FIG. 17, a pair of suction nozzles 62 is provided in the discharge port of a die 16 along a longitudinal direction of the die 16. Thereby, a flow in an opposite direction to the downward vertical direction is formed in the vicinity of a surface of a film 12A. Accordingly, the suction nozzles 62 straighten air in the vicinity of the surface of the film 12A, and can thereby reduce a variation of a wind speed.

A flow rate of the air flow which is formed by vacuum suction in the vicinity of the surface of the film 12A is preferably set at a value necessary for correcting the turbulence of the flow due to an ascending air current, and can be set at 0.6 to 1.0 m/second, for instance.

In the above described FIGS. 15 to 18, an example was shown in which the blowing nozzle 60 or the suction nozzle 62 was provided in the vicinity of the discharge port of the die 16. However, the place is not limited to the vicinity of the discharge port of the die 16, but may be provided in a lower side (cooling roll side) of the film 12A.

The melt film-formed thermoplastic film 12A in the above described way is preferably stretched longitudinally and transversely, and may be further combined with shrinkage treatment, as is illustrated in FIG. 19. Among the above processes, a preferable one is a process of longitudinally stretching the film and then transversely stretching the film, or is a process of combining an operation of transverse stretching with longitudinal shrinkage treatment. The former process is suitable for developing high Rth, and the latter process is suitable for developing low Rth.

When the film is treated with combined steps of the transverse stretching and the longitudinal shrinkage treatment, the longitudinal shrinkage treatment may be performed during the transverse stretching step, may be performed after the transverse stretching step, or may be performed both during and after the transverse stretching step. Furthermore, the longitudinal stretching step may be combined with the transverse stretching step, prior to or posterior to the transverse stretching step, or both prior to and posterior to the transverse stretching step. In addition, the film may be manufactured by the steps of: manufacturing the film 12A through a melt film-forming step; longitudinally and transversely stretching film continuously without temporarily winding the film with a winder 26; and then winding the film.

In the present invention, the film may be longitudinally stretched singly or in combination with the transverse stretching step. The film may be longitudinally stretched prior to or posterior to the transverse stretching step, but preferably is stretched prior to the transverse stretching step. The film may also be longitudinally stretched in one stage or in divided multiple stages.

The longitudinal stretching process can be achieved by providing two pairs of nip rolls, and controlling a peripheral speed of nip rolls in an outlet side so as to be higher than that of nip rolls in an inlet side, while heating the space between the nip rolls in the both sides. At this time, a developing way of retardation in a thickness direction can be changed by varying a length (L) between the nip rolls and a width (W) of a film before being stretched. Rth can be diminished by controlling L/W to more than 2 but 50 or less (long span stretching), and can be increased by controlling L/W to 0.01 or more but 0.3 or less (short span stretching). In the present invention, any method may be used among the long span stretching, the short span stretching and middle region stretching (in which middle stretching=L/W is more than 0.3 and 2 or less), but the long span stretching or the short span stretching is preferably used because of being capable of making the orientation angle small. Furthermore, it is preferable to employ the stretching method while distinguishing the stretching method in ways of employing the short span stretching when aiming at imparting high Rth, and employing the long span stretching when aiming at imparting low Rth.

The preferred stretching temperature in the longitudinal stretching process is preferably (Tg−10° C.) to (Tg+50)° C., more preferably is (Tg−5° C.) to (Tg+40)° C., and most preferably is (Tg) to (Tg+30)° C. A preferred stretching magnification is 2% to 200%, more preferably is 4% or more but 150% or less, and most preferably is 6% to 100%.

The film can be transversely stretched by using a tenter. Specifically, the tenter holds both ends in the width direction of the film with a clip, and expanding the film in a transverse direction to stretch the film. As this time, the stretching temperature can be controlled by sending air of a desired temperature to the tenter. The stretching temperature is preferably Tg−10° C. or more but Tg+60° C. or less, more preferably is Tg−5° C. or more but Tg+45° C. or less, and most preferably is Tg or more but Tg+30° C. or less. A preferred stretching magnification is 10% or more but 250% or less, more preferably is 20% or more but 200% or less, and most preferably is 30% or more but 150% or less. The stretching magnification described here is defined by the following expression.

Stretching magnification(%)=100×{(length after having been stretched)−(length before being stretched)}/(length before being stretched)

Various materials to be used in the present invention will now be described below.

### [Material of Thermoplastic Film]

A thermoplastic film to be used in the present invention is not particularly limited, but preferably includes cellulose-acylate-based resins, polymers containing a lactone ring, cyclic-olefin-based resins and polycarbonates. Among them, preferable one is the cellulose-acylate-based resins and the cyclic-olefin-based resins, more preferable one among them is cellulose acylate containing an acetate group and a propionate group, and a cyclic-olefin-based resin obtained through addition polymerization, and the most preferable one is the cyclic-olefin-based resin obtained through addition polymerization.

### (1) Cellulose-Acylate-Based Resin

A usable cellulose-acylate-based resin is the one described, for instance, in Japanese Patent Application Laid-Open No. 2006-45500, Japanese Patent Application Laid-Open No. 2006-241433, Japanese Patent Application Laid-Open No. 2007-138141, Japanese Patent Application Laid-Open No. 2001-188128, Japanese Patent Application Laid-Open No. 2006-142800 and Japanese Patent Application Laid-Open No. 2007-98917. A whole substitution degree of an acyl group is preferably 2.1 or more but 3.0 or less. The substitution degree of an acetyl group is preferably 0.05 or more but 2.5 or less, and more preferably is 0.05 or more but 0.5 or less, or is 1.5 or more but 2.5 or less. The substitution degree of a propionyl group is preferably 0.1 or more but 2.8 or less, and more preferably is 0.1 or more but 1.2 or less, or is 2.3 or more but 2.8 or less.

### (2) Cyclic-Olefin-Based Resin

A cyclic-olefin-based resin is preferably formed by polymerizing a norbornene-based compound. This polymerization reaction can be any of a ring-opening polymerization reaction and an addition polymerization reaction. A compound obtained through the addition polymerization reaction is described, for instance, in Japanese Patent No. 3517471, Japanese Patent No. 3559360, Japanese Patent No. 3867178, Japanese Patent No. 3871721, Japanese Patent No. 3907908, Japanese Patent No. 3945598, Japanese National Publication of International Patent Application No. 2005-527696, Japanese Patent Application Laid-Open No. 2006-28933 and WO 2006/004376. A particularly preferable compound is the one described in Japanese Patent No. 3517471.

A compound obtained through the ring-opening polymerization reaction is described, for instance, in WO 1998/14499, Japanese Patent No. 3060532, Japanese Patent No. 3220478, Japanese Patent No. 3273046, Japanese Patent No. 3404027, Japanese Patent No. 3428176, Japanese Patent No. 3687231, Japanese Patent No. 3873934 and Japanese Patent No. 3912159. Among them, preferable compounds obtained through the ring-opening polymerization reaction are ones described in WO 1998/14499 and Japanese Patent No. 3060532. Among the compounds, the cyclic olefin resin obtained through the addition polymerization is more preferable.

### (3) Polymer Containing Lactone Ring

The polymer is the one having a lactone ring structure expressed by the following general formula (1):

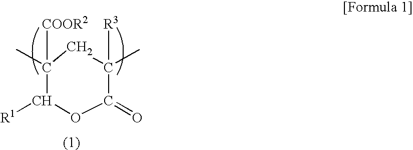

(wherein R¹, R² and R³ each independently represent a hydrogen atom or an organic residue having carbon number ranging 1 to 20, in which the organic residue may contain an oxygen atom.) A compound of the general formula (1) contains a lactone ring structure in a proportion of preferably 5 to 90 wt %, more preferably of 10 to 70 wt %, and most preferably of 10 to 50 wt %.

A polymer structural unit (repetitive structural unit) is preferable other than the lactone ring structure expressed by the general formula (1), which is structured by polymerizing at least one compound selected from a (meth)acrylic ester, a monomer containing a hydroxyl group, an unsaturated carboxylic acid and a monomer expressed by the following general formula (2a):

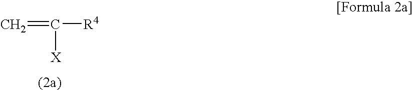

(wherein R⁴ represents a hydrogen atom or a methyl group; X represents a hydrogen atom, or an alkyl group, an aryl group, —OAc group, —CN group, —CO—R⁵ group or —C—O—R⁶ group each having carbon number ranging 1 to 20; an Ac group represents an acetyl group; and R⁵ and R⁶ represent a hydrogen atom or an organic residue having carbon number ranging 1 to 20.)

For instance, the polymer containing the lactone ring can employ a compound described in WO 2006/025445, Japanese Patent Application Laid-Open No. 2007-70607, Japanese Patent Application Laid-Open No. 2007-63541, Japanese Patent Application Laid-Open No. 2006-171464 and Japanese Patent Application Laid-Open No. 2005-162835.

### (4) Polycarbonate-Based Resin

This polycarbonate-based resin is a resin obtained by making a dihydroxy component react with a carbonate precursor through an interface polymerization process or a melt polymerization process, and can preferably employ the one described in Japanese Patent Application Laid-Open No. 2006-277914, Japanese Patent Application Laid-Open No. 2006-106386 and Japanese Patent Application Laid-Open No. 2006-284703.

### (5) Additive

These thermoplastic films can contain a plasticizer of alkyl phthalyl alkyl glycolates, phosphoric acid esters, carboxylic acid esters and polyhydric alcohols in an amount of 0 to 20 mass %, as an additive. A stabilizer in an amount of 0 to 3 mass % can be added to the thermoplastic resin, which includes: a phosphite-based stabilizer (for instance, tris(4-methoxy-3,5-diphenyl)phosphite, tris(nonylphenyl)phosphite and tris(2,4-di-t-butylphenyl)phosphite); a phenol-based stabilizer (for instance, 2,6-di-t-butyl-4-methylphenol, 2,2-methylenebis(4-ethyl-6-t-butylphenol), 2,5-di-t-butylhydroquinone, pentaerythrityl tetrakis [3-(3,5-di-t-butyl-4-hydroxyphenyl)propionate, 4,4-thio-bis-(6-t-butyl-3-methylphenol), 1,1-bis(4-hydroxyphenyl)cyclohexane, and octadecyl-3-(3,5-di-t-butyl-4-hydroxyphenyl)propionate]; an epoxy compound; and a thioether compound. A matting agent in a concentration of 0 to 1,000 ppm can be added to the thermoplastic resin, which includes: inorganic microparticles of silica, titania, zirconia, alumina, calcium carbonate, clay and the like; and organic microparticles of cross-linked acryl, cross-linked styrene and the like. It is also preferable to add a UV absorber (for instance, 2,4-dihydroxy benzophenone, 2-hydroxy-4-methoxy benzophenone and 2,2-methylenebis[4-(1,1,3,3-tetramethylbutyl)-6-[(2H-benzotriazol-2-yl)phenol]]), an infrared absorber and a retardation modifier to the thermoplastic resin.

### EXAMPLES

A feature of the present invention will now be described more specifically with reference to examples, but the scope of the present invention should not be definitely interpreted by the specific examples which will be described below.

### Example 1

In the present example, it was tested how much a surface state of a film 12A was improved, which was manufactured by shielding an air gap (molten resin film) between a die 16 and a cooling roll 18 of a touch roll type with a shielding plate 46, in a melt film-forming process in FIG. 3.

The film 12A was finally formed into a shape with a film thickness of 80 μm and a width after the end was slit of 1500 mm. A cycloolefin copolymer (hereinafter referred to as “COC”) was used as a raw material. The glass transition temperature Tg of the cycloolefin copolymer was 140° C.

The air gap between the discharge port of the die 16 and the surface of the cooling roll 18 was set at 100 mm. The temperature of the die 16 was set at 260° C., and the line speed was set at 20 m/second.

As the shielding plate 46, a metal plate was used which was made from a material of SUS304 and had a thickness of 5 mm. The shielding plate 46 was arranged only in both ends (side face) in a width direction of the film 12A. The shielding plate 46 was installed so that a clearance C2 between the shielding plate 46 and the side face of the die 16 was 5 mm (a clearance C1 between the shielding plate 46 and the end in the width direction of the film 12A was 50 mm), and a clearance C3 between the shielding plate 46 and the surface of the cooling roll 18 was 12 mm. An atmospheric temperature in a position which was 20 mm distant from the surface of the film 12A was adjusted to 80° C. with a temperature control mechanism illustrated in FIG. 7, and the wind speed and the wind temperature at the position were measured.

### (Method of Measuring Wind Speed and Wind Temperature)

A wind speed indicator Anemomaster (Main body: MODEL6162, and Probe: MODEL0204) made by Kanomax Japan, Inc. was used.

In five points in the width direction of the film 12A, which were 20 mm distant from the surface of the film 12A, a variation of the wind speed, an absolute value of the wind speed, and the wind temperature were each measured with time.

In addition, the surface temperatures of cooling rolls 18, 20 and 22 were controlled to 130° C. The thickness nonuniformity of the manufactured film was measured.

### (Method of Measuring Thickness)

The thickness was measured by using an off-line contact-type continuous thickness indicator (film thickness tester KG601B made by Anritsu Corporation) and by setting the measurement pitch at 1 mm. The thickness in a width direction of the film was measured in the full width of the film 12A after having been trimmed, and the thickness in a transport direction of the film was measured on the length of 3 m of the film 12A. The thickness nonuniformity was evaluated according to the following criteria.

Excellent . . . 1 μm or less in a range for thickness nonuniformity

Good . . . 2 μm or less in a range for thickness nonuniformity

Fair . . . 5 μm or less in a range for thickness nonuniformity

Poor . . . over 5 μm in a range for thickness nonuniformity

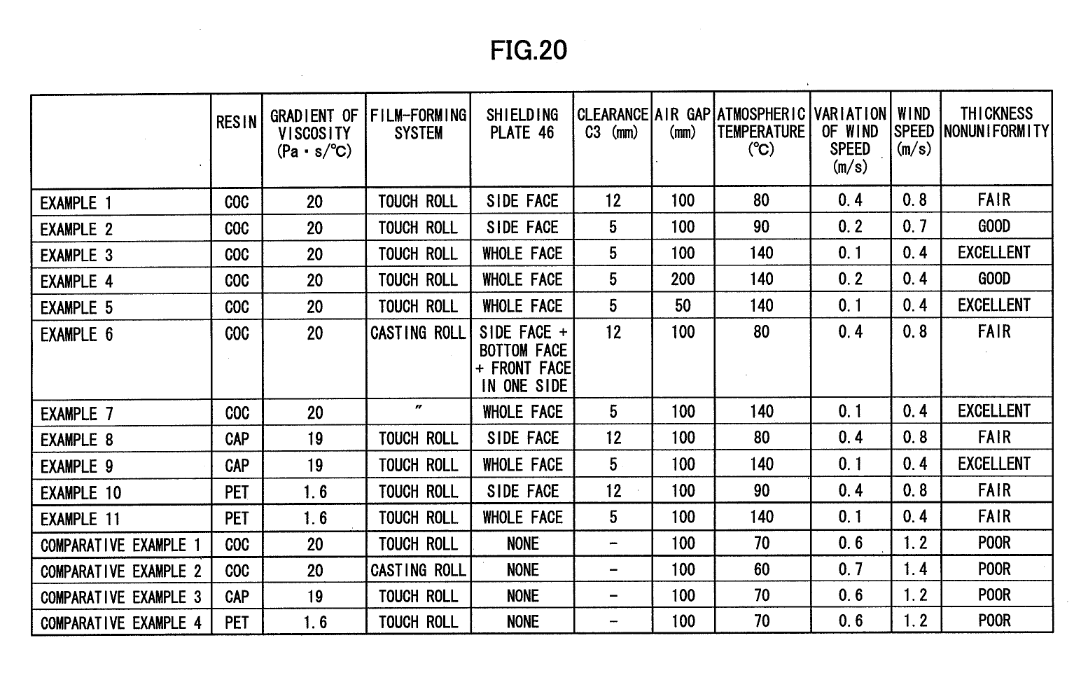

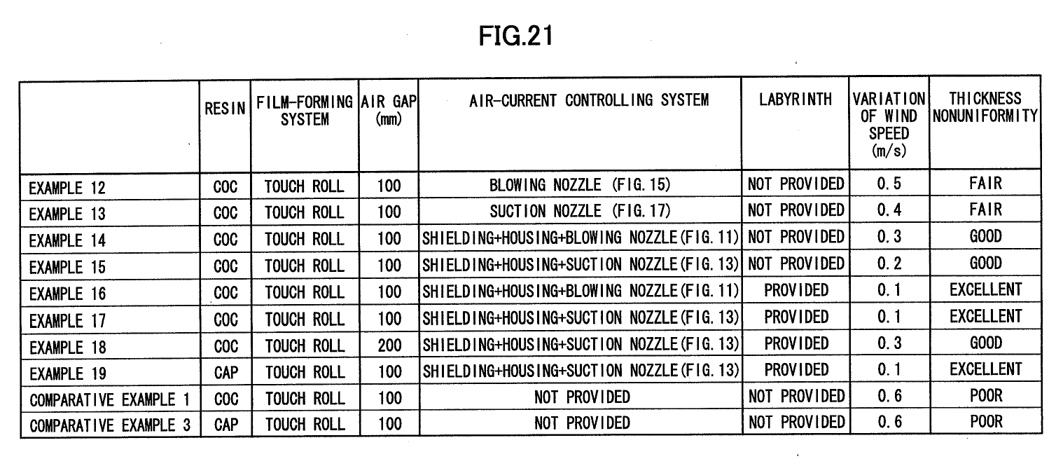

This result is shown in FIG. 20.

### Example 2

A film was manufactured in a similar way to that in Example 1, except that a shielding plate 46 was arranged so that a clearance C3 between the shielding plate 46 and the surface of a cooling roll 18 could be 5 mm. This result is shown in FIG. 20.

### Example 3

A film was manufactured in a similar way to that in Example 2, except that a shielding plate 46 was structured so as to surround not only both ends in a width direction of a film 12A, but also the whole periphery of the film 12A including the surface of the film 12A. This result is shown in FIG. 20.

### Example 4

A film was manufactured in a similar way to that in Example 3, except that an air gap (length of molten resin film) between a die 16 and a cooling roll 18 was set at 200 mm. This result is shown in FIG. 20.

### Example 5

A film was manufactured in a similar way to that in Example 3, except that an air gap (length of molten resin film) between a die 16 and a cooling roll 18 was set at 50 mm. This result is shown in FIG. 20.

### Example 6

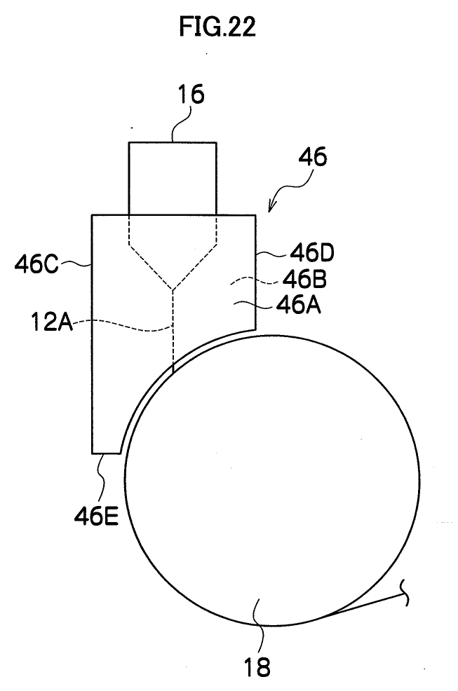

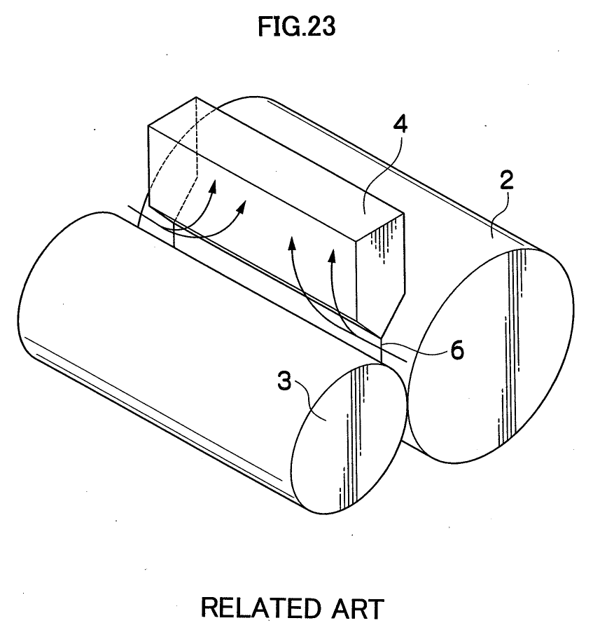

A film was manufactured in a similar way to that in Example 1, except that a cooling roll 18 of a casting roll type as illustrated in FIG. 22 was used in place of a cooling roll 18 of a touch roll type. In the above described case, a shielding plate 46 was provided in a side face 46A, a side face 46B, a front face 46C (side not contacting with cooling roll 18) and a bottom face 46E, which are illustrated in FIG. 22. This result is shown in FIG. 20.

### Example 7

A film was manufactured in a similar way to that in Example 6, except that a shielding plate 46 was structured so as to surround the whole periphery including the surface of the film 12A (a side face 46A, a side face 46B, a front face 46C, a front face 46D and a bottom face 46E), and a clearance C3 was changed to 5 mm. This result is shown in FIG. 20.

### Example 8

A film was manufactured in a similar way to that in Example 1, except that a type of resin was changed to cellulose acylate propionate (hereinafter referred to as “CAP”) from a cycloolefin copolymer. The glass transition temperature Tg of cellulose acylate propionate is 135° C. This result is shown in FIG. 20.

### Example 9

A film was manufactured in a similar way to that in Example 8, except that a shielding plate 46 was structured so as to surround not only both ends in a width direction of the film 12A but the whole periphery including the surface of the film 12A, and a clearance C3 was changed to 5 mm. This result is shown in FIG. 20.

### Example 10

A film was manufactured in a similar way to that in Example 1, except that a type of resin was changed to polyethylene terephthalate (hereinafter referred to as “PET”) from a cycloolefin copolymer, and an atmospheric temperature in a position which is 20 mm distant from the surface of the film 12A was set at 90° C. The polyethylene terephthalate has the glass transition temperature Tg of 70° C. This result is shown in FIG. 20.

### Example 11

A film was manufactured in a similar way to that in Example 10, except that a shielding plate 46 was structured so as to surround not only both ends in a width direction of the film 12A but the whole periphery including the surface of the film 12A, and a clearance C3 was changed to 5 mm. This result is shown in FIG. 20.

### Comparative Example 1

A film was manufactured in a similar way to that in Example 1, except that a shielding plate 46 was not provided. This result is shown in FIG. 20.

### Comparative Example 2

A film was manufactured in a similar way to that in Example 6, except that a shielding plate 46 was not provided. This result is shown in FIG. 20.

### Comparative Example 3

A film was manufactured in a similar way to that in Example 8, except that a shielding plate 46 was not provided. This result is shown in FIG. 20.

### Comparative Example 4

A film was manufactured in a similar way to that in Example 10, except that a shielding plate 46 was not provided. This result is shown in FIG. 20.

As is understood from the table in FIG. 20, any apparatus of Examples 1 to 11, in which a shielding plate 46 was provided between a die 16 and the surface of a cooling roll 18, showed a variation of a wind speed 0.5 m/second or less in the vicinity of the surface of the film 12A, and showed an adequate result of showing small thickness nonuniformity. In addition, any apparatus of the above described Examples 1 to 11 showed the wind speed as small as 1 m/second by an absolute value and did not show a recognizable adverse effect to the thickness nonuniformity.

In contrast to this, any apparatus of Comparative examples 1 to 4, in which the shielding plate 46 was not provided between the die 16 and the surface of the cooling roll 18, showed the variation of the wind speed exceeding 0.5 m/second in the vicinity of the surface of the film 12A, and it was confirmed that the variation caused much thickness nonuniformity. The Comparative examples also showed such large absolute values of the wind speeds as 1.2 m/second or larger.

In addition, it was confirmed that the variation of the wind speed in the vicinity of the surface of the film 12A is reduced (Examples 1 and 2) by decreasing a clearance C3 between the surface of the cooling roll 18 and the shielding plate 46 and consequently enhancing the shielding properties of the shielding plate. It was also confirmed that the thickness nonuniformity was significantly reduced (Example 3) by installing the shielding plate 46 in the whole periphery of the film 12A to enhance the shielding properties of the shielding plate 46 and decrease the variation of the wind speed in the vicinity of the surface of the film 12A to 0.1 m/second or less. Furthermore, it was also confirmed that it was also effective for reducing the variation of the wind speed (Examples 3, 4 and 5) to shorten the air gap and thereby enhance the shielding properties of the film 12A.

It was confirmed that the variation of the wind speed in the vicinity of the surface of the film 12A was reduced and the thickness nonuniformity could be reduced (Examples 6 and 7) in a casting roll system as well as in a touch roll system, by installing the shielding plate 46 at least in one side of a front face (front face 46C), a side face and a bottom face of the film 12A, and preferably installing the shielding plate 46 on the whole face.

In addition, it was confirmed that when cellulose acylate propionate or polyethylene terephthalate was used as a resin, the same tendency as in a cycloolefin copolymer was shown (Examples 8 to 11).

From the above results, it was confirmed that the thickness nonuniformity of the film could be reduced by applying the present invention to an apparatus for manufacturing a thermoplastic resin film.

Subsequently, an effect was examined for a case of reducing a variation of a wind speed in the vicinity of the surface of a film 12A by using an air-current control system.

### Example 12

A variation of a wind speed in the vicinity of the surface of a film 12A and the thickness nonuniformity of the film 12A were measured in a similar way to that in Example 1, except that air was passed along the surface of the film 12A by a blowing nozzle 60 illustrated in FIG. 15. This result is shown in the Table of FIG. 21.

### Example 13

A variation of a wind speed in the vicinity of the surface of a film 12A was measured in a similar way to that in Example 1, except that air was passed along the surface of the film 12A by a suction nozzle 62 illustrated in FIG. 17. This result is shown in the Table of FIG. 21.

### Example 14

A variation of a wind speed in the vicinity of the surface of a film 12A was measured in a similar way to that in Example 1, except that an air flow was formed in the outside of both ends in a width direction of the film 12A by a blowing nozzle 54 provided in a housing which was prepared by removing a labyrinth from a housing 52 illustrated in FIG. 11. This result is shown in the Table of FIG. 21.

### Example 15

A variation of a wind speed in the vicinity of the surface of a film 12A was measured in a similar way to that in Example 1, except that an air flow was formed in the outside of both ends in a width direction of the film 12A by a suction nozzle 58 provided in a housing which was prepared by removing a labyrinth from a housing 52 illustrated in FIG. 13. This result is shown in the Table of FIG. 21.

### Example 16

A variation of a wind speed in the vicinity of the surface of a film 12A was measured in a similar way to that in Example 1, except that an air flow was formed in the outside of both ends in a width direction of the film 12A by a blowing nozzle 54 provided in a housing 52 (having labyrinth) illustrated in FIG. 11. This result is shown in the Table of FIG. 21.

### Example 17

A variation of a wind speed in the vicinity of the surface of a film 12A was measured in a similar way to that in Example 1, except that an air flow was formed in the outside of both ends in a width direction of the film 12A by a suction nozzle 58 provided in a housing 52 (having labyrinth) illustrated in FIG. 13. This result is shown in the Table of FIG. 21.

### Example 18

A variation of a wind speed in the vicinity of the surface of a film 12A was measured in a similar way to that in Example 17, except that an air gap (length of molten resin film) between a die 16 and a cooling roll 18 was set at 200 mm. This result is shown in the Table of FIG. 21.

### Example 19

A variation of a wind speed in the vicinity of the surface of a film 12A was measured in a similar way to that in Example 17, except that a type of resin was changed to cellulose acylate propionate (hereinafter referred to as “CAP”) from a cycloolefin copolymer. This result is shown in the Table of FIG. 21.

As is understood from the Table of FIG. 21, each of Examples 12 and 13 shows a case of straightening air along the surface of the film 12A by passing air along the surface. Each of Examples 14 to 19 shows a case of preventing an ascending air current from colliding with the vicinity of the surface of the film 12A by forming an air flow in the outside of both ends in a width direction of the film 12A. Each of Comparative examples 1 and 3 shows a case of not controlling the air current in such a way as was described above.

Any apparatus of Examples 12 to 19 showed a variation of a wind speed of 0.5 m/second or less in the vicinity of the surface of the film 12A, and could control its thickness nonuniformity to 5 μm or less.

In contrast to this, any apparatus of Comparative examples 1 and 3 showed the variation of the wind speed exceeding 0.5 m/second in the vicinity of the surface of the film 12A, and it was confirmed that the variation caused much thickness nonuniformity.

Apparatuses of Examples 14 to 19 which use a housing 52 together with a blowing nozzle 54 or a suction nozzle 58 showed a variation of a wind speed of 0.3 m/second or less in the vicinity of the surface of the film 12A, and could make their thickness nonuniformities small. Furthermore, when an apparatus employs a shielding mechanism of passing an air flow though a labyrinth mechanism 56 in the housing 52, and then forming an air flow in the outside of both ends in a width direction of the film 12A, the apparatus could effectively shield the ascending air current without disturbing a wind speed in the vicinity of the surface of the film 12A (Examples 16 to 19).

From the above results, it was confirmed that the thickness nonuniformity of the film could be reduced by applying the present invention to an apparatus for manufacturing a thermoplastic resin film.

What is claimed is:

1. An apparatus for manufacturing a thermoplastic resin film comprising:
a die which discharges a molten thermoplastic resin as a film;
a cooling roll which is arranged so as to oppose to a discharge port of the die, and cools and solidifies the discharged film; and
a shielding device which shields at least an end in a width direction of the film until the film lands on a surface of the cooling roll after having been discharged from the discharge port of the die, between an end in a width direction of the cooling roll and the end in the width direction of the film.

2. The apparatus for manufacturing the thermoplastic resin film according to claim 1, wherein
the shielding device is a shielding plate which is provided in an approximately orthogonal direction to a surface of the film, between the end in the width direction of the cooling roll and the end in the width direction of the film.

3. The apparatus for manufacturing the thermoplastic resin film according to claim 2, wherein
a distance between the shielding plate and the end in the width direction of the film is 50 mm or less.

4. The apparatus for manufacturing the thermoplastic resin film according to claim 2, wherein
the shielding device is provided so as to further surround the perimeter of the surface of the film.

5. The apparatus for manufacturing the thermoplastic resin film according to claim 1, wherein
the shielding device comprises:
a housing which surrounds a space between a surface of the die in a longitudinal direction and the surface of the cooling roll, and has a labyrinth mechanism formed therein; and
an air-flow forming device which forms air flow in an approximately orthogonal direction to the surface of the film, on the both ends in a width direction of the housing.

6. The apparatus for manufacturing the thermoplastic resin film according to claim 5, wherein
the air-flow forming device is a blowing nozzle or a suction nozzle.

7. An apparatus for manufacturing a thermoplastic resin film comprising:
a die which discharges a molten thermoplastic resin as a film;
a cooling roll which is arranged so as to oppose to a discharge port of the die, and cools and solidifies the discharged film; and
an air-straightening device which is provided in the vicinity of the discharge port of the die and straightens air in the vicinity of a surface of the film, until the film lands onto a surface of the cooling roll after having been discharged from the discharge port of the die.

8. The apparatus for manufacturing the thermoplastic resin film according to claim 7, wherein
the air-straightening device is provided in the vicinity of the discharge port of the die, and is a blowing nozzle or a suction nozzle which sends or sucks air in parallel to a discharging direction of the film.

9. The apparatus for manufacturing the thermoplastic resin film according to claim 1, further comprising:
a measuring device which measures a temperature in the vicinity of the surface of the film; and
a heating device which heats the vicinity of the surface of the film to a predetermined temperature based on the measured result.

10. The apparatus for manufacturing the thermoplastic resin film according to claim 1, wherein
an air gap between the discharge port of the die and a point where the film lands on the surface of the cooling roll is 200 mm or less.

11. The apparatus for manufacturing the thermoplastic resin film according to claim 1, further comprising
a touch roll which is provided adjacent to the cooling roll, wherein
the discharge port of the die is provided in a position lower than any one of the vertex of the cooling roll and the vertex of the touch roll.

12. A method for manufacturing a thermoplastic resin film comprising the step of
reducing a variation of a wind speed in the vicinity of the surface of the film using the apparatus for manufacturing the thermoplastic resin film according to claim 1.

13. A method for manufacturing a thermoplastic resin film comprising the steps of:
discharging a molten thermoplastic resin from a die as a film;
cooling and solidifying the discharged film on a cooling roll, and
controlling a variation of a wind speed in the vicinity of a surface of the discharged film to be 0.5 m/second or less.

14. The method for manufacturing the thermoplastic resin film according to claim 13, further comprising the step of
straightening air in the vicinity of the surface of the film, until the film lands onto a surface of the cooling roll after having been discharged from the die.

15. The method for manufacturing the thermoplastic resin film according to claim 14, wherein
the air-straightening is performed by sending or sucking air in parallel to a discharging direction of the film.

16. The method for manufacturing the thermoplastic resin film according to claim 13, further comprising the step of
controlling a wind speed in the vicinity of the surface of the film to be 1 m/second or less.

17. The method for manufacturing the thermoplastic resin film according to claim 13, further comprising the step of
controlling a temperature difference between the vicinity of the surface of the film and the die to be 160° C. or lower.

18. The method for manufacturing the thermoplastic resin film according to claim 13, wherein
the cooling roll is a touch roll type.

19. The method for manufacturing the thermoplastic resin film according to claim 13, wherein
the thermoplastic resin shows a gradient of a viscosity of 1.7 Pa·s/° C. or higher by an absolute value, while the thermoplastic resin is in a temperature range of (T−10)° C. or higher but T° C. or lower, when a temperature of the molten resin right after having been discharged from the die is defined as T (° C.).

20. The method for manufacturing the thermoplastic resin film according to claim 13, wherein
the thermoplastic resin is a cellulosic resin or a cyclic-olefin-based resin.

21. The method for manufacturing the thermoplastic resin film according to claim 13, wherein
the film has a thickness nonuniformity of 1 μm or less.
